(19) United States
(12) Patent Application Publication
(10) Pub. No.: US 2007/0166182 A1
(43) Pub. Date: Jul. 19, 2007

(54) PNEUMATIC TOOL

(75) Inventor: Jui-Sheng Chang, Wu-Jih Shiang (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: MIGHTY SEVEN INTERNATIONAL CO., LTD., Wu-Jih Shiang (TW)

(21) Appl. No.: 11/307,017

(22) Filed: Jan. 19, 2006

(51) Int. Cl. F01C 19/02; F01C 19/00; F04C 15/00; F03C 2/00; F03C 4/00

(52) U.S. Cl. 418/140; 418/112

(57) ABSTRACT

A pneumatic tool is provided with a cylinder assembly. The cylinder assembly includes a cylinder, two steel plates and two covers. The cylinder defines an axial bore, two grooves on an external side and two groups of intakes in communication with the axial bore. Each of the steel plates defines an eccentric opening, two slots and two cutouts in an external edge. The steel plates are located against the cylinder so that the cutouts are in communication with the grooves. Each of the covers defines an eccentric opening and two grooves extending on a side to an external edge. The covers are attached to the cylinder so that the grooves of the cylinder are in communication with the slots through the cutouts and the grooves of the covers.

### BACKGROUND OF INVENTION

1. Field of Invention

The present invention relates to a pneumatic tool and, more particularly, to a cylinder assembly of a pneumatic tool.

2. Related Prior Art

Referring to FIGS. 8 and 9, there is shown a conventional cylinder assembly of a pneumatic tool. The cylinder assembly includes a cylinder 70, a steel plate 80 and a cover 90.

The cylinder 70 defines an eccentric bore 71 for receiving a rotor. Because of the eccentric bore 71, the cylinder 70 includes a thick portion and a thin portion opposite to the thick portion. Defined in an end of the thick portion of the cylinder 70 are two grooves 72 and two intakes 73 within the grooves 72. Defined in the thin portion of the cylinder 70 is an outlet 74.

The steel plate 80 defines an axial aperture 81, two arched first slots 82 on a side and two arched second slots 83 on the side. The axial aperture 81 receives a shaft of the rotor.

The cover 90 defines an axial aperture 91 corresponding to the axial aperture 81, two first grooves 92 corresponding to the first slots 82, two second grooves 93 corresponding to the second slots 83 and two grooves 94 for communicating the first grooves 92 with the second grooves 93.

Pressurized air goes into the first slots 82 of the steel plate 80 from the intakes 73 of the cylinder 70 through the grooves 94 of the cover 90 so as to cause the blades of the rotor to extend. The pressurized air goes into the second slots 83 so as to rotate the rotor.

As the cylinder 70 is made of metal powder in a powder metallurgic method or molten metal in a casting method, the cylinder 70 is generally thick. Because of the eccentric bore 71, the cylinder 70 includes the thick portion. Hence, the cylinder 70 is heavy and expensive.

The present invention is therefore intended to obviate or at least alleviate the problems encountered in prior art.

### SUMMARY OF INVENTION

According to the present invention, a pneumatic tool is provided with a cylinder assembly. The cylinder assembly includes a cylinder, two steel plates and two covers. The cylinder defines an axial bore, two grooves on an external side and two groups of intakes in communication with the axial bore. Each of the steel plates defines an eccentric opening, two slots and two cutouts in an external edge. The steel plates are located against the cylinder so that the cutouts are in communication with the grooves. Each of the covers defines an eccentric opening and two grooves extending on a side to an external edge. The covers are attached to the cylinder so that the grooves of the cylinder are in communication with the slots through the cutouts and the grooves of the covers.

An advantage of the cylinder assembly according to the present invention is smoothness due to the use of the seamless form.

Another advantage of the cylinder assembly according to the present invention is thin and light because of the cylinder defines the axial bore and does not include any thick portion.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a pneumatic tool including a cylinder assembly according to the preferred embodiment of the present invention.

FIG. 2 is an exploded view of the cylinder assembly shown in FIG. 1.

FIG. 3 is a front view of the cylinder assembly shown in FIG. 1.

FIG. 4 is a top view of the cylinder assembly shown in FIG. 3.

FIG. 5 is a cross-sectional view of the cylinder assembly along a line 5-5 in FIG. 4.

FIG. 6 is a top view of the cylinder assembly in another position than shown in FIG. 4.

FIG. 7 is a cross-sectional view of the cylinder assembly along a line 7-7 in FIG. 6.

FIG. 8 is a front view of a conventional cylinder of a pneumatic tool.

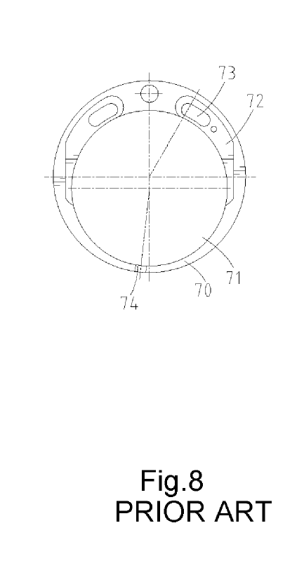

FIG. 9 is a front view of a conventional steel plate and cover for use with the cylinder shown in FIG. 8.

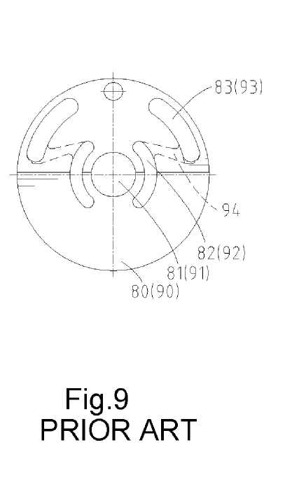

### DETAILED DESCRIPTION OF PREFERRED EMBODIMENT

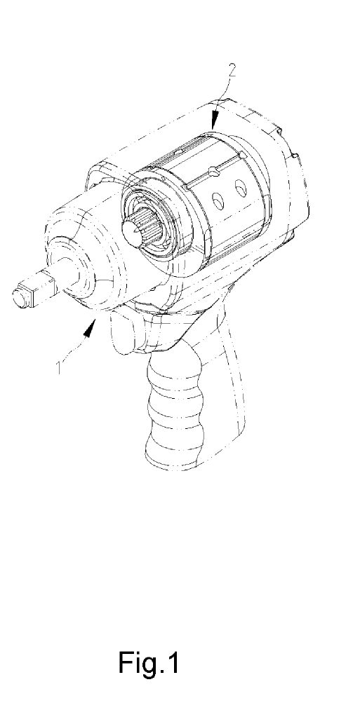

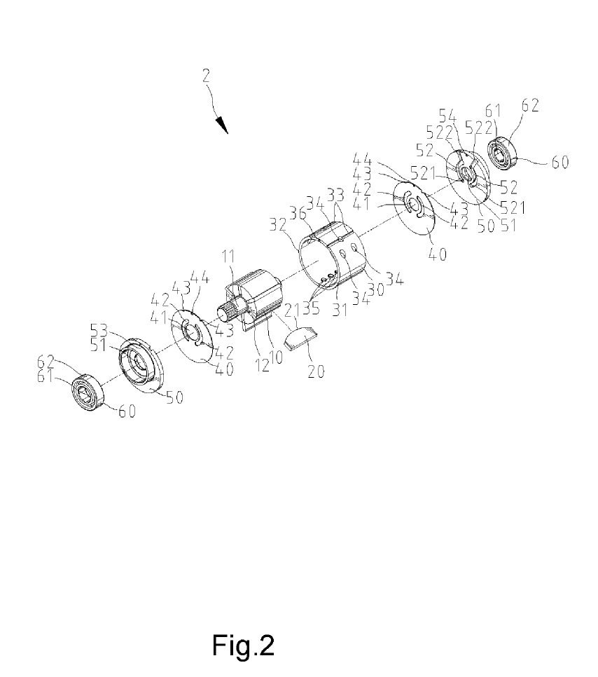

Referring to FIGS. 1 and 2, a pneumatic tool 1 is provided with a cylinder assembly 2 according to the preferred embodiment of the present invention. The cylinder assembly 2 is used together with a rotor 10 and a plurality of blades 20.

The rotor 10 includes two shafts 11 at two ends. One of the shafts 11 is formed with teeth. A plurality of grooves 12 is longitudinally defined in the rotor 10.

Each of the blades 20 includes an arched edge 21 and a straight edge. The blades 20 are movably installed in the grooves 12 so that the arched edges 21 are always located in the grooves 12 while the straight edges can be moved from the grooves 12.

The cylinder assembly 2 includes a cylinder 30, two steel plates 40, two covers 50 and two bearings 60.

The cylinder 30 is used to receive the rotor 10 and the blades 20. The cylinder 30 is a section of a seamless steel pipe. Therefore, the cylinder 30 includes a high superficial density and excellent smoothness, and is durable and hard. The cylinder 30 defines an axial bore. Hence, the cylinder 30 does not include any thick portion, and is generally thin. The cylinder 30 includes a first half 31 and a second half 32 opposite to the first half 31. A longitudinal groove 33 extends in each of the halves 31 and 32. A plurality of intakes 34 is defined in each of the halves 31 and 32. One of the intakes 34 is located in the halve 31 or 32 while the other intakes 34 are located near the halve 31 or 32. A series of outlets 35 is defined in the cylinder 30 between the halves 31 and 32. A positioning hole 36 is defined in each edge of the cylinder 30 opposite to the outlets 35.

Each of the steel plates 40 defines an eccentric opening 41, two arched slots 42 around the eccentric opening 41, two cutouts 43 defined in the edge and a positioning hole 44 between the cutouts 43. The openings 41 of the steel plates 40 receive the shafts 11 of the rotor 10. The cutouts 43 are made corresponding to the grooves 33. The positioning hole 44 is made corresponding to the positioning hole 36.

Each of the covers 50 defines an eccentric opening 51, two grooves 52 on a side, an annular lip 53 on an opposite side and a positioning hole 54. The eccentric openings 51 of the covers 50 receive the shafts 11 of the rotor 10. Each of the grooves 52 includes an arched section 521 around the eccentric opening 51 and a straight section 522 extending from the arched section 521 to an external edge. The arched sections 521 of the grooves 52 are made corresponding to the arched slots 42. The positioning hole 54 is made corresponding to the positioning hole 44.

The bearings 60 are ball bearings. Each of the bearings 60 includes an internal ring 61 fit on related one of the shafts 11 and an external ring 62 fit in the annular lip 53.

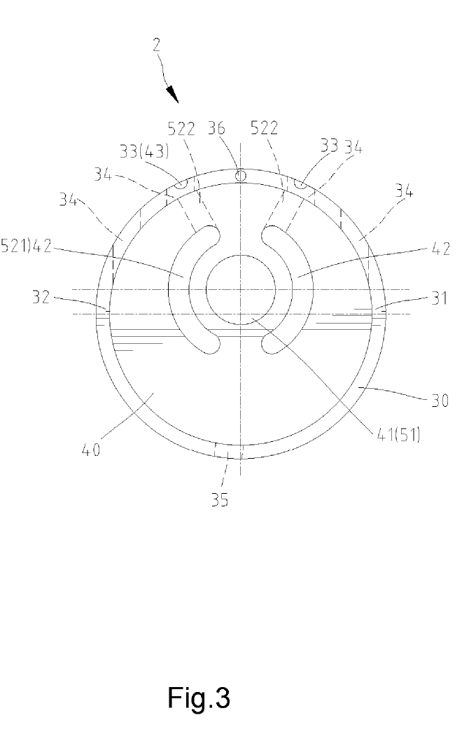

Referring to FIG. 3, the cylinder 30, one of the steel plates 40 and related one of the covers 50 are shown. The eccentric opening 41 of the steel plate 40 is in communication with the eccentric opening 51 of the cover 50. The arched slots 42 of the steel plate 40 are in communication with the arched sections 521 of the grooves 52 of the cover 50. The straight sections 522 of the grooves 52 of the cover 50 are in communication with the grooves 33 of the cylinder 30.

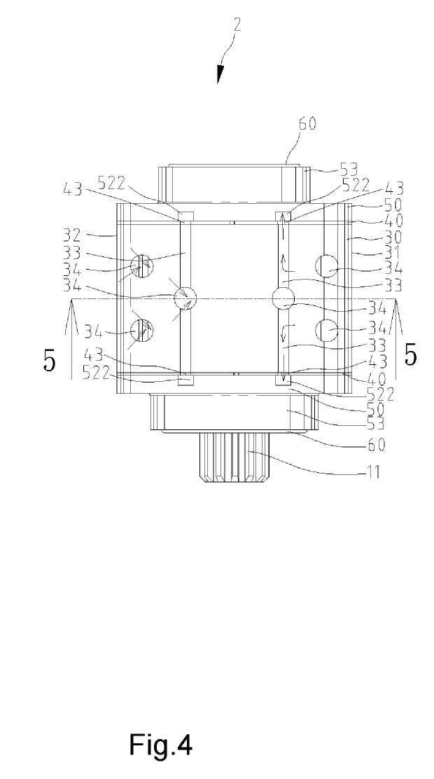

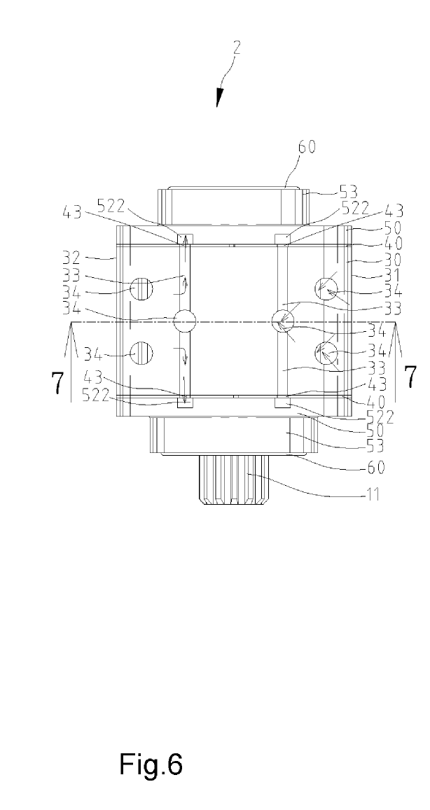

Referring to FIGS. 4 through 7, described is the operation of the cylinder assembly 2. Pressurized air goes into the cylinder assembly 2 along two paths.

Along the first path, the pressurized air goes to the ends of the cylinder 30 along the grooves 33. The pressurized air goes into the grooves 52 of the covers 50 from the grooves 33 of the cylinder 30 through the cutouts 43 of the steel plates 40. The pressurized air goes into the cylinder 30 from the grooves 52 of the covers 50 through the slots 42 of the steel plates 40. The pressurized air goes into the grooves 12. The pressurized air blows the arched edges 21 of the blades 20, thus causing the straight edges of the blades 20 to extend from the grooves 12 of the rotor 10.

Along the second path, the pressurized air goes into the cylinder 30 through the intakes 34, and blows the straight edges of the blades 20, causing the blades 20 and the rotor 10 to rotate. Finally, the pressurized air leaves the cylinder 30 from the outlets 35.

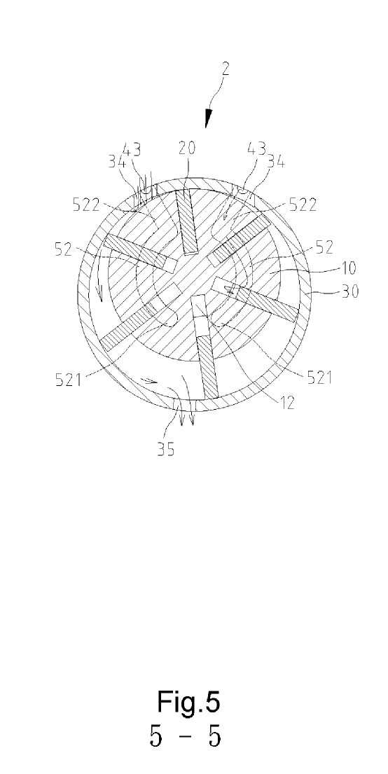

Referring to FIG. 5, the rotor 10 rotates counterclockwise. The pressurized air goes into the cylinder 30 through the groove 33 on the first half 31, and causes the straight edges of the blades 20 to emerge from the grooves 12 of the rotor 10. On the other hand, the pressurized air goes into the cylinder 30 through the intakes 34 on the second half 32, and causes the blades 20 and the rotor 10 to rotate counterclockwise.

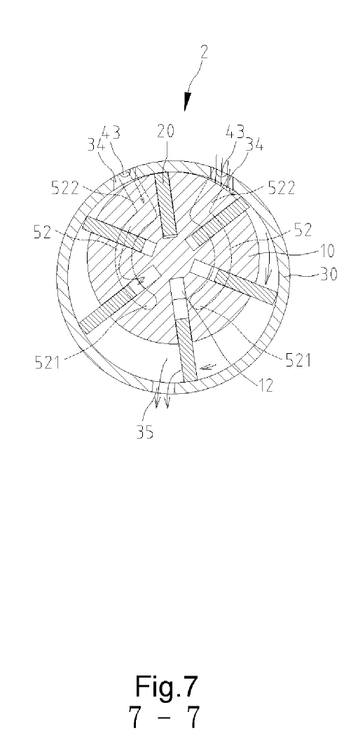

Referring to FIG. 7, the rotor 10 rotates clockwise. The pressurized air goes into the cylinder 30 through the groove 33 on the second half 32, and causes the straight edges of the blades 20 to emerge from the grooves 12 of the rotor 10. On the other hand, the pressurized air goes into the cylinder 30 through the intakes 34 on the first half 31, and causes the blades 20 and the rotor 10 to rotate clockwise.

The cylinder assembly 2 according to the present invention exhibits several advantages because the cylinder 30 is a section of a seamless steel tube. The cylinder 30 is thin and light. The cylinder 30 provides a high superficial density and excellent smoothness. The cylinder 30 is durable and hard. The cost is low.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A cylinder assembly comprising:
a cylinder defining an axial bore, two grooves on an external side and two groups of intakes in communication with the axial bore;
two steel plates each defining an eccentric opening, two slots and two cutouts in an external edge, wherein the steel plates are attached to the cylinder so that the cutouts are in communication with the grooves; and
two covers each defining an eccentric opening and two grooves extending on a side to an external edge, wherein the covers are attached to the cylinder so that the grooves of the cylinder are in communication with the slots through the cutouts and the grooves of the covers.

2. The cylinder assembly according to claim 1 wherein the cylinder is a section of a seamless steel pipe.

3. The cylinder assembly according to claim 1 wherein each of the groups is located near related one of the grooves of the cylinder.

4. The cylinder assembly according to claim 3 wherein each of the groups comprises at least one intake within the related groove.

5. The cylinder assembly according to claim 4 wherein each of the groups comprises at least one intake outside the related groove.

6. The cylinder assembly according to claim 1 wherein the cylinder defines at least one outlet opposite to the inlets.

7. The cylinder assembly according to claim 1 wherein the slots of the steel plates are arched around the eccentric opening of the steel plates.

8. The cylinder assembly according to claim 1 wherein each of the grooves of each of the covers comprises an arched section about the eccentric opening of the related cover and a straight section extending from the arched section.

9. The cylinder assembly according to claim 1 wherein each of the covers comprises an annular lip on an opposite side.

10. The cylinder assembly according to claim 9 comprising two bearings each fit in the annular lip of related one of covers.

11. The cylinder assembly according to claim 1 wherein the axial bore of the cylinder is for receiving a rotor.

12. The cylinder assembly according to claim 1 wherein the eccentric openings of the steel plates are for receiving two shafts extending from a rotor.

13. The cylinder assembly according to claim 1 wherein the eccentric openings of the covers are for receiving two shafts extending from a rotor.
